(19) United States
(12) Patent Application Publication
(10) Pub. No.: US 2021/0180197 A1
(43) Pub. Date: Jun. 17, 2021

(54) WATER ELECTROLYSIS SYSTEM AND CONTROL METHOD THEREOF

(71) Applicants: HYUNDAI MOTOR COMPANY, Seoul (KR); KIA MOTORS CORPORATION, Seoul (KR)

(72) Inventor: Seung Hyeon Choi, Suwon-si (KR)

(21) Appl. No.: 16/916,982

(22) Filed: Jun. 30, 2020

(30) Foreign Application Priority Data
Dec. 12, 2019 (KR) 10-2019-0166031

(51) Int. Cl. C25B 15/02; C25B 9/06; C25B 9/18; C25B 1/04; C25B 15/08; C25B 9/04

(52) U.S. Cl. CPC C25B 15/02; C25B 9/06; C25B 9/04; C25B 1/04; C25B 15/08; C25B 9/18

(57) ABSTRACT

A water electrolysis system includes a pair of electrolytic cells for accommodating electrolytic water supplied from an electrolytic water tank and connected to a hydrogen tank and an oxygen tank, a pair of active electrodes including a cathode and an anode being accommodated in the electrolytic cells and connected to electric power by an active electrode lead to electrolyze electrolytic water to produce hydrogen and oxygen, auxiliary electrodes accommodated in the electrolytic cells and connected by an auxiliary electrode lead to provide electrons to the separated electrolytic cells or receive electrons therefrom, sensors for measuring pressure of hydrogen or oxygen generated in the electrolytic cells and measure electrolytic water capacity of the electrolytic cells, and a controller for selectively discharging a hydrogen or oxygen gas upon receiving a measurement value of a sensor, selectively supplying electrolytic water to the electrolytic cells from the electrolytic water tank, and selectively controlling a current direction of the electric power.

### CROSS REFERENCE TO RELATED APPLICATIONS

The present application claims priority to Korean Patent Application No. 10-2019-0166031, filed Dec. 12, 2019, the entire contents of which is incorporated herein for all purposes by this reference.

### BACKGROUND

### 1. Technical Field

The present disclosure relates to a water electrolysis system and a control method thereof, and more particularly, to a system in which electrolytic cells are separated, eliminating the necessity of a membrane, and hydrogen and oxygen are generated alternately in a pair of electrolytic cells through an oxidation/reduction reaction by controlling an application direction of a current, and a control method in which the system is circulated.

### 2. Description of the Related Art

Hydrogen, which is very high in energy density and environmentally friendly energy with the highest energy density per unit mass, has come to prominence as a next generation energy source. Methods for producing hydrogen with high energy density include various methods such as fossil fuel reforming, a by-product gas that occurs in industrial processes, biomass gasification, and water electrolysis using renewable energy.

Water electrolysis among the hydrogen producing methods is a method of obtaining hydrogen by separating water molecules into hydrogen molecules and oxygen molecules using electricity. Water electrolysis is an environmentally friendly hydrogen producing method and is the most reliable technology among hydrogen producing methods. Water electrolysis is also known as the cheapest hydrogen producing technology which is simple in configuration of a system and stable in operation.

A water electrolysis device of a related art includes a membrane as an essential component to produce hydrogen and oxygen in a single electrolytic cell and separate hydrogen and oxygen. Here, since a high-priced membrane is necessary, a price of the water electrolysis device is increased, and when the membrane is operated or pressed at a low load, a cross-over phenomenon that hydrogen and oxygen pass through the membrane occurs.

In order to solve the problem, a water electrolysis device using in which electrolytic cells are separated and an auxiliary electrode is used has been developed. However, in the disclosed water electrolysis device, the electrolytic cells are simply separated and an anode continuously produces only hydrogen and a cathode continuously produces oxygen, making it difficult for the water electrolysis device to be commercialized as an automatic circulating system.

### SUMMARY

An object of the present disclosure is to provide a water electrolysis system in which an electrolytic cell is separated, thus eliminating the necessity of a membrane, and hydrogen and oxygen are alternately produced and circulate by controlling a direction of a current applied to the electrolytic cell, and a control method thereof.

According to an embodiment of the present disclosure, a water electrolysis system includes a pair of separate electrolytic cells configured to accommodate electrolytic water supplied from an electrolytic water tank and connected to a hydrogen tank and an oxygen tank, a pair of active electrodes including a cathode and an anode, the cathode and the anode being accommodated in the pair of electrolytic cells and connected to electric power by an active electrode lead to electrolyze electrolytic water to produce hydrogen and oxygen, respectively, auxiliary electrodes respectively accommodated in the pair of electrolytic cells and connected to each other by an auxiliary electrode lead to provide electrons to the separated electrolytic cells or receive electrons therefrom, a plurality of sensors configured to measure pressure of hydrogen or oxygen generated in the electrolytic cells and to measure an electrolytic water capacity of the electrolytic cells, and a controller configured to control to selectively discharge a hydrogen gas or oxygen gas upon receiving a measurement value of a sensor, to control to selectively supply electrolytic water to the electrolytic cells from the electrolytic water tank, and to selectively control a current direction of the electric power.

The sensor may include a pressure sensor configured to measure a pressure of hydrogen or oxygen generated in each electrolytic cell and an electrolytic water sensor configured to measure an electrolytic water capacity and the pressure sensor and the electrolytic water sensor may be positioned on the electrolytic cells, respectively.

The water electrolysis system may further include at least one pipe connected to each electrolytic cell to form a flow path allowing a hydrogen or oxygen gas generated in the active electrodes to be discharged to a hydrogen tank or an oxygen tank and having a gas valve provided at an inlet for discharging a gas from the electrolytic cell to selectively open and close the flow path.

The pipe may include a hydrogen pipe connected to the hydrogen tank and having a hydrogen valve and an oxygen pipe connected to the oxygen tank and having an oxygen valve, and the hydrogen valve and the oxygen valve may be controlled to be selectively opened and closed by the controller.

The pipe may be configured as a single pipe connected to the electrolytic cells and having a branching point connected to the hydrogen tank or the oxygen tank, and a three-way valve is provided at the branching point.

The controller may be configured to control to open the oxygen valve of the electrolytic water accommodating the anode and open the hydrogen valve of the electrolytic water accommodating the cathode to store a gas in the oxygen tank and the hydrogen tank, when a pressure of a gas measured by the pressure sensor reaches a predetermined gas discharge pressure.

The predetermined gas discharge pressure may be 20 bar or higher.

The controller may control to supply electrolytic water to the electrolytic cell to entirely discharge a remaining gas, when the gas generated in the electrolytic water is discharged and a pressure of the gas measured by the pressure sensor is equal to or lower than a predetermined electrolytic water replenishment pressure.

The predetermined electrolytic water replenishment pressure may be 1 bar or lower.

The controller may control to open an electrolytic water valve when a capacity of the electrolytic water measured by the electrolytic water sensor is less than or equal to a predetermined capacity, and control to close the electrolytic water valve when the predetermined capacity is reached.

When the electrolytic water reaches a predetermined capacity, the controller may control to close both the gas valve and the electrolytic water valve and to apply a current by changing a direction of a current applied from the electric power, and as the direction of the current is reversed, the cathode is changed into the anode and the anode is changed into the cathode and an operation of the system is circulated.

In addition, the pair of electrolytic cells may be continuously provided in plurality and operated by the same controller.

The electrolytic water may be a NaOH or KOH aqueous solution.

According to another embodiment of the present disclosure, a method of controlling a water electrolysis system includes a current applying operation of applying a current to active electrodes in one direction, a gas generating operation of generating hydrogen in the active electrode providing an electron and generating oxygen in the active electrode receiving an electron; a gas storing operation of storing a gas generated in an electrolytic cell, an electrolytic water replenishing operation of replenishing electrolytic water in the electrolytic cell, and a current re-applying operation of re-performing the gas generating operation by applying a current to the active electrode in the other direction.

The gas storing operation may include a gas discharging operation of controlling, by a controller, to discharge the gas to a hydrogen tank and an oxygen tank when a pressure of the produced hydrogen or oxygen reaches a predetermined gas discharge pressure, and a discharge stopping operation of blocking the connection between the hydrogen tank, the oxygen tank, and the electrolytic cell to stop discharging of the gas when a pressure of the electrolytic cell is lowered to a predetermined electrolytic water replenishment pressure.

The gas discharge pressure may be 20 bar and the electrolytic water replenishment pressure may be 1 bar.

The electrolytic water replenishing operation may include: an electrolytic water introducing operation of introducing electrolytic water by controlling, by the controller, to connect the electrolytic cell and the electrolytic water tank, and a current re-application preparing operation of blocking, by the controller, the connection between the electrolytic cell and the electrolytic water and stopping current application when a capacity of the electrolytic water reaches a predetermined capacity.

### BRIEF DESCRIPTION OF THE FIGURES

FIGS. 1A and 1B are views illustrating a water electrolysis system according to an embodiment of the present disclosure.

FIG. 2 is a flowchart of a method of controlling a water electrolysis system according to an embodiment of the present disclosure.

FIG. 3 is a view illustrating a current applying operation and a gas generating operation of a water electrolysis system according to an embodiment of the present disclosure.

FIG. 4 is a view illustrating a gas storing operation of a water electrolysis system according to an embodiment of the present disclosure.

FIGS. 5 and 6 are views illustrating an electrolytic water replenishing operation of a water electrolysis system according to an embodiment of the present disclosure.

FIG. 7 is a view illustrating a current re-applying operation of a water electrolysis system according to an embodiment of the present disclosure.

### DETAILED DESCRIPTION

Specific structural or functional descriptions of the embodiments of the present disclosure disclosed in the specification are exemplified for the purpose of describing the embodiments of the present disclosure only, and the embodiments of the present disclosure may be carried out in various forms and should not be construed to limit the embodiments described herein.

The terms used in the application are used to describe specific embodiments only and are not intended to limit the present disclosure. A singular expression includes a plural expression as long as they are clearly distinguished in the context. In the application, it should be understood that the terms such as “comprising”, “including” are intended to express that features, numbers, steps, operations, constituent elements, part, or combinations thereof described in the specification are present and do not exclude existence or additions of one or more other features, numbers, steps, operations, constituent elements, part, or combinations thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

Hereinafter, embodiments of the present disclosure will be described in detail with reference to the accompanying drawings. The same constituent elements in the drawings are denoted by the same reference numerals.

The present disclosure relates to a water electrolysis system for producing hydrogen and a control method thereof and relates to a circulation system in which a current is applied to a pair of electrolytic cells 100 which are independently separated to produce oxygen in an active electrode 200 of the electrolytic cell 100 in which an oxidation reaction takes place and produce hydrogen in the active electrode 200 of the electrolytic cell 100 in which a reduction reaction takes place, and here, a direction in which the current is applied is reversed at a specific time point to cause oxidation/reduction reactions to take place conversely.

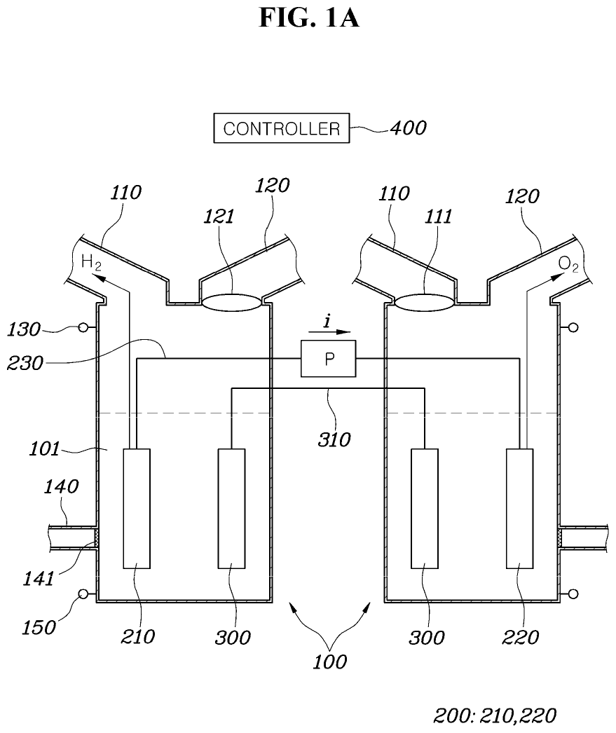

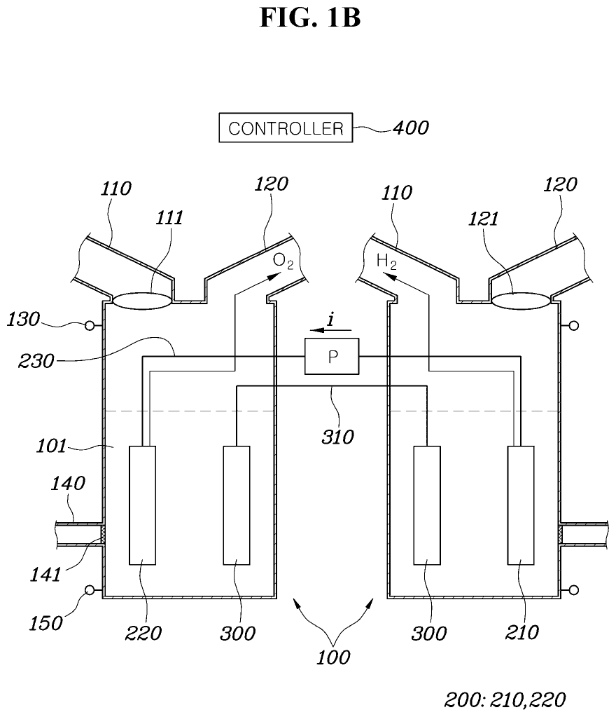

FIGS. 1A and 1B are views illustrating a water electrolysis system according to an embodiment of the present disclosure.

Referring to FIGS. 1A and 1B, the water electrolysis system according to an embodiment of the present disclosure may include the electrolytic cell 100, the active electrode 200, an auxiliary electrode 300, a sensor, and a controller 400. The water electrolysis system may further include at least one pipe forming a flow path through which a gas moves.

The electrolytic cell 100 may accommodate electrolytic water 101 and the active electrode 200 by which an electrolysis reaction takes place to produce hydrogen or oxygen. The electrolytic cell 100 may be configured as a pair separated independently. In the related art, both the active electrode 200 in which the oxidation reaction takes place and the active electrode 200 in which the reduction reaction takes place are accommodated in one electrolytic cell 100, but in the present disclosure, the electrolytic cell 100 is separated as a pair and the pair of separated electrolytic cells 100 may accommodate the active electrodes 200 respectively. Since the oxidation or reduction reaction takes place alternately in each active electrode, there is no possibility that gases are mixed, and thus no expensive membrane is required.

The electrolytic water 101 supplied from an electrolytic water tank may be accommodated in each electrolytic cell 100. The electrolytic water 101 may be an alkaline solution such as KOH or NaOH. In addition, each electrolytic cell 100 may be connected to a hydrogen tank for storing hydrogen and an oxygen tank for storing oxygen to store the generated hydrogen or oxygen.

The electrolytic cell 100 may have an electrolytic water inlet 140 that receives the electrolytic water 101 from the electrolytic water tank. The electrolytic water 101 is replenished through the electrolytic water inlet 140, and the electrolytic water inlet 140 may have an electrolytic water valve 141. The electrolytic water valve 141 may selectively open and close the electrolytic water inlet 140 to control introduction of the electrolytic water 101 from the electrolytic water tank.

The active electrode 200 is connected to an electric power P, receives a current, and produces oxygen or hydrogen by electrolyzing the electrolytic water 101. The active electrode 200 needs to have a low overvoltage and high corrosion resistance when hydrogen or oxygen is generated, and an electrode having low resistance under a condition of the alkaline electrolytic water 101 may be used as the active electrode 200.

The active electrodes 200 accommodated respectively in the electrolytic cells 100 may be connected to the electric power P by an active electrode lead 230. When a current is applied from the electric power P, one of the active electrodes 200 becomes a positive electrode and the other becomes a negative electrode. The current flows from the positive electrode to the negative electrode, and when a direction of the current is reversed, the positive electrode and negative electrode are interchanged each other.

In the present disclosure, the active electrode 200 in which oxygen is generated is defined as an anode 220 and the active electrode 200 in which hydrogen is generated is defined as a cathode 210. As illustrated in FIGS. 1A and 1B, the cathode 210 and the anode 220 may be converted to each other according to a direction in which the current is applied. Even the same active electrode 200 may become a cathode 210 or an anode 220 according to the direction in which the current is applied, and hydrogen or oxygen is generated depending on whether the active electrode 200 is the cathode 210 or the anode 220.

The auxiliary electrode 300 may be configured as a pair, and the pair of auxiliary electrodes 300 may be accommodated respectively in the electrolytic cells 100 to provide or receive electrons of the electrolytic water 101 to or from the other electrolytic cell 100. The auxiliary electrodes 300 are connected to each other by an auxiliary electrode lead 310.

The sensor may perform a sensing function to measure a pressure of a hydrogen or oxygen gas generated in the electrolytic cell 100 and may measure a capacity of the electrolytic water 101. The sensor may include a pressure sensor 130 provided at the top of the electrolytic cell 100 to measure a pressure of a gas and an electrolytic water sensor 150 provided at the bottom of the electrolytic cell 100 to measure a capacity of the electrolytic water 101. The pressure sensor 130 and the electrolytic water sensor 150 may be provided at each electrolytic cell 100 to measure a gas pressure generated in each electrolytic cell 100 and a capacity of the electrolytic water 101.

The controller 400 may receive a measurement value from the pressure sensor 130 and control to selectively discharge the hydrogen or oxygen gas according to situations. When the pressure of the gas is higher than or equal to a gas discharge pressure, the controller 400 may control to discharge the hydrogen or oxygen gas, and when the pressure of the gas is lower than an electrolytic water replenishment pressure, the controller 400 may control to replenish the electrolytic water 101 to discharge all the remaining gas.

In addition, the controller 400 may receive a measurement value from the electrolytic water sensor 150 and control to supply the electrolytic water 101 from the electrolytic water tank to the electrolytic cell 100. Here, the electrolytic water valve 141 may be opened to supply the electrolytic water 101 of the electrolytic water tank to the electrolytic cell 100.

In addition, the controller 400 may determine the cathode 210 and the anode 220 by controlling a direction of the current applied from the electric power P to selectively reverse the direction of the current. Details of the function of the controller 400 will be described later.

The pipe may be connected to the electrolytic cell 100 to form a flow path in which the hydrogen or oxygen gas generated in the active electrode 200 is discharged to the hydrogen tank or the oxygen tank. Gas valves 111 and 121 selectively opening and closing the flow paths may be provided at inlets through which the gas is discharged to the pipes from the electrolytic cells 100, respectively. One or a plurality of pipes may be provided at the electrolytic cells 100.

As illustrated in FIGS. 1A and 1B, the pipe may include a hydrogen pipe 110 connected to a hydrogen tank and an oxygen pipe 120 connected to an oxygen tank. A hydrogen valve 111 may be provided at the hydrogen pipe 110, and an oxygen valve 121 may be provided at the oxygen pipe 120.

Since the controller 400 may control the direction of the current flowing in the active electrode lead 230 by the electric power P, the controller 400 may selectively open and close the gas valves 111 and 121 depending on whether each active electrode 200 is the cathode 210 or the anode 220. Details thereof will be described later.

Although not shown in the drawings, the electrolytic cell 100 may have only a single pipe, a branching point branched from the pipe to each of the hydrogen tank or oxygen tank, and a three-way valve may be provided at the branching point. The controller 400 may control the three-way valve to selectively connect the pipe to the hydrogen tank or the oxygen tank to form a flow path for the hydrogen gas to move to the hydrogen tank and the oxygen gas to move to the oxygen tank. That is, the controller 400 may control the gas valves 111 and 121 to be connected to the hydrogen tank when the active electrode 200 is the cathode 210 and control the gas valves 111 and 121 to be connected to the oxygen tank when the active electrode 200 is the anode 220, depending on the direction of the current applied to the active electrode lead 230 from the electric power P.

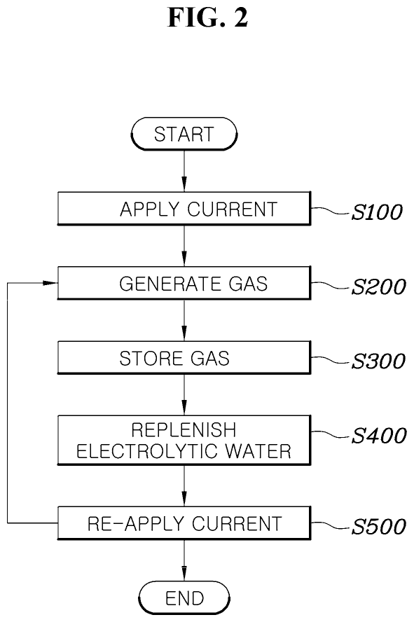

FIG. 2 is a flowchart of a method of controlling a water electrolysis system according to an embodiment of the present disclosure.

Referring to FIG. 2, the method of controlling a water electrolysis system according to an embodiment of the present disclosure may include a current applying operation S100, gas generating operation S200, gas storing operation S300, electrolytic water replenishing operation S400, and a current re-applying operation S500. Each operation will be described together with the drawings.

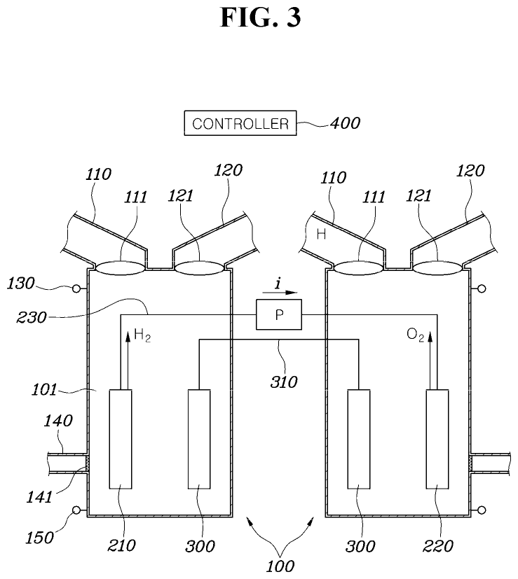

FIG. 3 is a view illustrating the current applying operation S100 and the gas generating operation S200 of a water electrolysis system according to an embodiment of the present disclosure.

Referring to FIG. 3, the current applying operation S100 is an operation in which a current starts to flow in the active electrode lead 230 by the electric power P. Here, the active electrode 200 connected to a positive electrode is the anode 220 in which an oxidation reaction takes place to generate oxygen, and the active electrode 200 connected to a negative electrode is the cathode 210 in which a reduction reaction takes place to generate hydrogen. A current flows from the cathode 210 to the anode 220. That is, the active electrode 200 that receives electrons becomes the cathode 210, and the active electrode 200 that provides electrons becomes the anode 220. Here, the reactions taking place in the cathode 210 and the anode 220 are as follows.

[Reaction Formula]

Anode: 4OH−→2H₂0+4e⁻+O₂

Cathode: 4H₂O+2e⁻→4OH⁻+2H₂

The current applying operation S100 is performed in a state where the hydrogen valve 111, the oxygen valve 121, and the electrolytic water valve 141 are all closed.

The gas generating operation S200 is an operation in which hydrogen or oxygen starts to be generated in each active electrode 200 when a current is applied to the active electrode lead by the electric power P in the preceding current applying operation S100.

As the reaction of the reaction formula takes place, hydrogen is generated in the cathode 210 and oxygen is generated in the anode 220. The gas generating operation S200 is performed in a state where both the hydrogen valve 111 and the oxygen valve 121 are closed. Hydrogen or oxygen is generated in each electrolytic cell 100 in the gas generating operation S200, and here, since the hydrogen valve 111 and the oxygen valve 121 are both in a closed state, gases are collected at the top of the electrolytic cell 100.

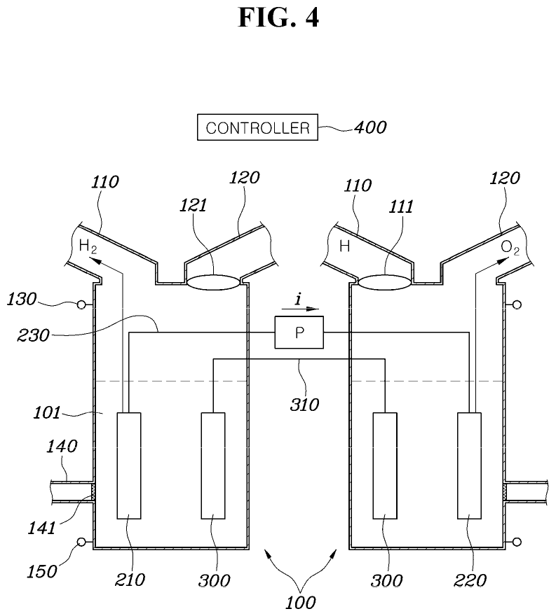

FIG. 4 is a view illustrating the gas storing operation S300 of a water electrolysis system according to an embodiment of the present disclosure.

The pressure sensor 130 measures a gas pressure of the electrolytic cell 100 and transmits the measured gas pressure to the controller 400. The controller 400 discharges and stores the gas when the pressure of the gas measured by the pressure sensor 130 reaches a predetermined gas discharge pressure.

Specifically, in the case of the electrolytic cell 100 in which the cathode 210 is accommodated, the controller 400 controls to open the hydrogen valve 111 provided at the hydrogen pipe 110 to allow the hydrogen gas to move to the hydrogen tank. Here, the oxygen valve 121 at the oxygen pipe 120 is maintained in the closed state, the hydrogen gas may move only to the hydrogen tank through the hydrogen pipe 110.

In addition, in the case of the electrolytic cell 100 in which the anode 220 is accommodated, the controller 400 controls to open the oxygen valve 121 provided at the oxygen pipe 120 to allow the oxygen gas to move to the hydrogen tank. Here, since the hydrogen valve 111 of the hydrogen pipe 110 is maintained in the closed, the oxygen gas may move only to the oxygen tank through the oxygen pipe 120.

The gas discharge pressure may be set to an appropriate pressure at which the hydrogen or oxygen gas being produced may be discharged through the hydrogen pipe 110 or the oxygen pipe 120, respectively, and may be preferably set to a pressure of 20 bar or higher.

In the gas storing operation S300, the current is continuously applied, and thus the oxidation or reduction reaction takes place continuously in the active electrode. In addition, in the gas storing operation S300, the water electrolytic valve is maintained in a closed state.

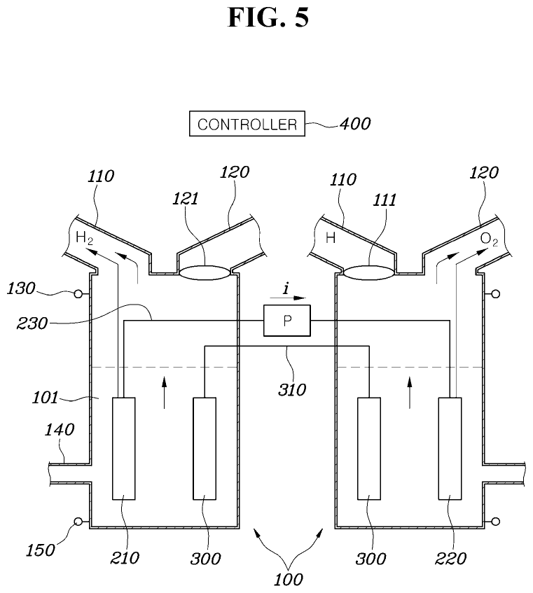

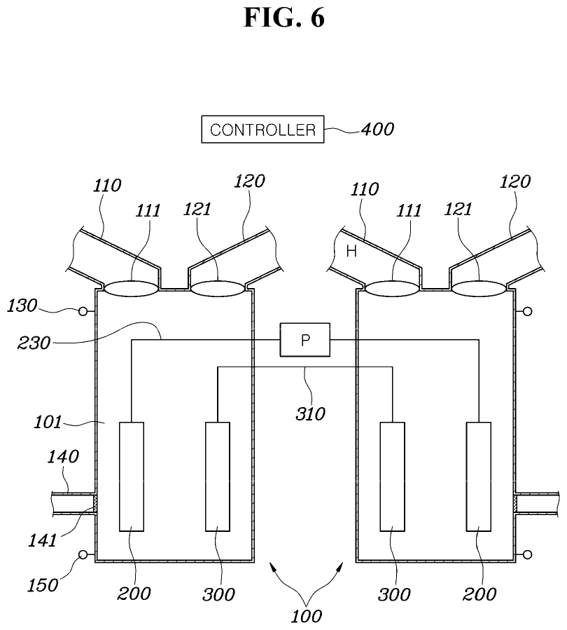

FIGS. 5 and 6 are views illustrating the electrolytic water replenishing operation S400 of a water electrolysis system according to an embodiment of the present disclosure.

The electrolytic water replenishing operation S400 is an operation of replenishing the electrolytic water 101 in the electrolytic cell 100.

When the gas escapes in the gas storing operation S300, the pressure of the electrolytic cell 100 is gradually lowered. The controller 400 controls both the hydrogen valve 111 and the oxygen valve 121 to be closed in order to stop discharging of the gas when the pressure of the gas measured by the pressure sensor 130 reaches a predetermined electrolytic water replenishment pressure. The electrolytic water replenishment pressure may be set to a pressure of a state in which gas is sufficiently discharged, and may be preferably set to 1 bar or lower.

The electrolytic water sensor 150 may continuously measure a capacity of the electrolytic water 101 accommodated in the electrolytic cell 100 and transmit the measured capacity to the controller 400. The controller 400 may control to open the electrolytic water valve 141 if the capacity of the electrolytic water 101 measured by the electrolytic water sensor 150 is less than or equal to a predetermined reference capacity. When the electrolytic water valve 141 is opened, electrolytic water 101 flows into the electrolytic cell 100 and a level of the electrolytic water 101 rises. Referring to FIG. 5, all of the remaining hydrogen or oxygen gas is discharged as the level of the electrolytic water 101 rises.

Referring to FIG. 6, when the hydrogen and oxygen gases are discharged and the electrolytic water 101 is sufficiently replenished to reach a predetermined capacity or greater, the controller 400 controls the electrolytic water valve 141 to be closed again. In addition, the controller 400 may close both the oxygen valve 121 and the hydrogen valve 111 to prevent the gases from being mixed and control to temporarily stop current application. That is, an initial state before applying the electric power P is achieved.

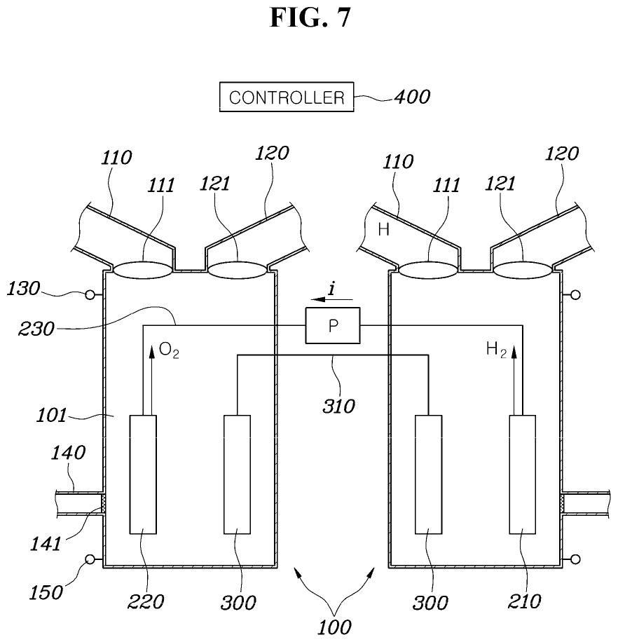

FIG. 7 is a view illustrating the current re-applying operation S500 of a water electrolysis system according to an embodiment of the present disclosure.

The current re-applying operation S500 is an operation of applying a current again by reversing the direction of the current after the electrolytic water 101 is replenished. As the direction of the current is reversed, the cathode 210 is changed into the anode 220, and the anode 220 is changed into the cathode 210.

Referring to FIG. 7, the current is applied from the electric power P by changing the direction of the electrode. In other words, the direction of the current is opposite to that of the previous cycle. Accordingly, the anode 220 in which the oxidation reaction occurred to produce oxygen is changed into the anode 210, and the cathode 210 in which the reduction reaction occurred to produce hydrogen is changed into the anode 220. In addition, the direction of electrons flowing in the auxiliary electrode lead 310 is also reversed. After the current re-applying operation S500, the gas generating operation S200 is performed again, circulating the cycle to produce hydrogen or oxygen.

As the water electrolysis system according to an embodiment of the present disclosure, the system in which hydrogen or oxygen takes place in the pair of electrolytic cells 100 is used as an example, but here, it may be configured as a module type in which the pair of electrolytic cell 100 are continuously provided. In the case of the module type, a large amount of hydrogen may be produced at a time by applying a current.

In the water electrolysis system and the control method thereof of the present disclosure, since the cathode in which hydrogen is produced and the anode in which oxygen is produced are accommodated in the independent and separate electrolytic cells, there is no possibility that the gases are mixed with each other, thereby eliminating the necessity of a membrane, and thus hydrogen may be produced economically and efficiently. In addition, since the water electrolysis system is configured as a circulating system by controlling an application direction of a current, hydrogen and oxygen may be continuously produced, facilitating the operation of the system.

Although the present disclosure has been illustrated and described with respect to specific embodiments, it will be apparent to those having ordinary skill in the art that the present disclosure may be variously modified and altered without departing from the spirit and scope of the present disclosure as defined by the following claims.

1. A water electrolysis system comprising:
a pair of separate electrolytic cells configured to accommodate electrolytic water supplied from an electrolytic water tank and connected to a hydrogen tank and an oxygen tank;
a pair of active electrodes including a cathode and an anode, the cathode and the anode being accommodated in the pair of electrolytic cells and connected to electric power by an active electrode lead to electrolyze electrolytic water to produce hydrogen and oxygen, respectively;
auxiliary electrodes respectively accommodated in the pair of electrolytic cells and connected to each other by an auxiliary electrode lead to provide electrons to the separated electrolytic cells or receive electrons therefrom;
a plurality of sensors configured to measure pressure of hydrogen or oxygen generated in the electrolytic cells and to measure an electrolytic water capacity of the electrolytic cells; and
a controller configured to control to selectively discharge a hydrogen gas or oxygen gas upon receiving a measurement value of a sensor, to control to selectively supply electrolytic water to the electrolytic cells from the electrolytic water tank, and to selectively control a current direction of the electric power.

2. The water electrolysis system of claim 1, wherein the sensor includes a pressure sensor configured to measure a pressure of hydrogen or oxygen generated in each electrolytic cell and an electrolytic water sensor configured to measure an electrolytic water capacity and the pressure sensor and the electrolytic water sensor are positioned on the electrolytic cells, respectively.

3. The water electrolysis system of claim 2, further comprising:
at least one pipe connected to each electrolytic cell to form a flow path allowing a hydrogen or oxygen gas generated in the active electrodes to be discharged to a hydrogen tank or an oxygen tank and having a gas valve positioned at an inlet for discharging a gas from the electrolytic cell to selectively open and close the flow path.

4. The water electrolysis system of claim 3, wherein the pipe includes a hydrogen pipe connected to the hydrogen tank and having a hydrogen valve and an oxygen pipe connected to the oxygen tank and having an oxygen valve, and the hydrogen valve and the oxygen valve are controlled to be selectively opened and closed by the controller.

5. The water electrolysis system of claim 3, wherein the pipe is configured as a single pipe connected to the electrolytic cells and having a branching point connected to the hydrogen tank or the oxygen tank, and a three-way valve is positioned at the branching point.

6. The water electrolysis system of claim 5, wherein the controller is configured to control to open the oxygen valve of the electrolytic water accommodating the anode and open the hydrogen valve of the electrolytic water accommodating the cathode to store a gas in the oxygen tank and the hydrogen tank, when a pressure of a gas measured by the pressure sensor reaches a predetermined gas discharge pressure.

7. The water electrolysis system of claim 6, wherein the predetermined gas discharge pressure is 20 bar or higher.

8. The water electrolysis system of claim 6, wherein the controller controls to supply electrolytic water to the electrolytic cell to entirely discharge a remaining gas, when the gas generated in the electrolytic water is discharged and a pressure of the gas measured by the pressure sensor is equal to or lower than a predetermined electrolytic water replenishment pressure.

9. The water electrolysis system of claim 8, wherein the predetermined electrolytic water replenishment pressure is 1 bar or lower.

10. The water electrolysis system of claim 9, wherein the controller controls to open an electrolytic water valve when a capacity of the electrolytic water measured by the electrolytic water sensor is less than or equal to a predetermined capacity, and controls to close the electrolytic water valve when the predetermined capacity is reached.

11. The water electrolysis system of claim 10, wherein, when the electrolytic water reaches a predetermined capacity, the controller controls to close both the gas valve and the electrolytic water valve and to apply a current by changing a direction of a current applied from the electric power, and as the direction of the current is reversed, the cathode is changed into the anode and the anode is changed into the cathode and an operation of the system is circulated.

12. The water electrolysis system of claim 1, wherein the pair of electrolytic cells are continuously provided in plurality and operated by the same controller.

13. The water electrolysis system of claim 1, wherein the electrolytic water may be a NaOH or KOH aqueous solution.

14. A method of controlling a water electrolysis system, the method comprising:
a current applying operation of applying a current to active electrodes in one direction;
a gas generating operation of generating hydrogen in the active electrode providing an electron and generating oxygen in the active electrode receiving an electron;
a gas storing operation of storing a gas generated in an electrolytic cell;
an electrolytic water replenishing operation of replenishing electrolytic water in the electrolytic cell; and
a current re-applying operation of re-performing the gas generating operation by applying a current to the active electrode in the other direction.

15. The method of claim 14, wherein the gas storing operation includes:
a gas discharging operation of controlling, by a controller, to discharge the gas to a hydrogen tank and an oxygen tank when a pressure of the produced hydrogen or oxygen reaches a predetermined gas discharge pressure; and
a discharge stopping operation of blocking the connection between the hydrogen tank, the oxygen tank, and the electrolytic cell to stop discharging of the gas when a pressure of the electrolytic cell is lowered to a predetermined electrolytic water replenishment pressure.

16. The method of claim 14, wherein the gas discharge pressure is 20 bar and the electrolytic water replenishment pressure is 1 bar.

17. The method of claim 15, wherein the electrolytic water replenishing operation includes:
an electrolytic water introducing operation of introducing electrolytic water by controlling, by the controller, to connect the electrolytic cell and the electrolytic water tank; and
a current re-application preparing operation of blocking, by the controller, the connection between the electrolytic cell and the electrolytic water and stopping current application when a capacity of the electrolytic water reaches a predetermined capacity.
